(19) United States
(12) Patent Application Publication
(10) Pub. No.: US 2015/0081961 A1
(43) Pub. Date: Mar. 19, 2015

(54) METHOD AND DEVICE FOR IDENTIFYING INFORMATION FOR CHIP-LEVEL PARALLEL FLASH MEMORY

(71) Applicant: Ajou University Industry-Academic, Suwon (KR)

(72) Inventors: Se Jin Kwon, Seoul (KR); Tae Sun Chung, Suwon (KR); Hyung Ju Cho, Yongin (KR)

(21) Appl. No.: 14/552,208

(22) Filed: Nov. 24, 2014

Related U.S. Application Data
(63) Continuation of application No. PCT/KR2013/000933, filed on Feb. 6, 2013.

(30) Foreign Application Priority Data
May 23, 2012 (KR) 10-2012-0054551

(51) Int. Cl. G06F 12/02

(52) U.S. Cl. CPC G06F 12/0246; G06F 2212/1044; G06F 2212/2022; G06F 2212/7203
USPC 711/103

(57) ABSTRACT

The present invention relates to an information identifying algorithm, and more particularly, to a method and device for identifying write operation information transmitted from a file system to a page-set or block-set type flash memory by utilizing an attribute information page-set buffer and a user information page-set buffer. In order to achieve such an object, the present invention includes a buffering layer for efficiently re-configuring write operation information from a file system to a page-set or block-set type flash memory. The device for identifying write operation information according to one embodiment of the present invention includes: a size determination unit; a logical address determination unit; an attribute information page-set buffer; a user information page-set buffer; a partial user information page-set buffer; a full page-set determination unit; and a session end determination unit.

### CROSS-REFERENCE TO RELATED APPLICATION

This application is a continuation of PCT/KR2013/000933 filed on Feb. 6, 2013, which claims priority to Korean Application No. 10-2012-0054551 filed on May 23, 2012, which application is incorporated herein by reference.

### TECHNICAL FIELD

The present invention relates to a flash translation layer and, more particularly, to a managing method and storage device to identify and re-configure write operation information transmitted from a file system to a page-set or block-set type flash memory.

### BACKGROUND ART

The rate of use of flash memory in mobile electronic devices is rapidly increasing because flash memory is superior to a conventional hard disk in terms of access speed, power consumption, noise, durability, vibration, etc.

Furthermore, flash memory alone may be used as a portable storage device in nonvolatile memory form, may be used as a secondary cache for reducing a bottleneck phenomenon between a hard disk and a disk cache and reducing the power consumption of a disk cache, and may be used for a hybrid hard disk drive (hybrid HDD) combined with an existing hard disk or a solid state disk (hereinafter abbreviated to “SSD”) in which a plurality of flash memory chips has been incorporated into a single storage device.

Flash memory may be classified into NOR flash memory chiefly having the characteristics of existing random memory and NAND flash memory chiefly having the characteristics of a storage medium, such as a hard disk.

The degree of integration of NAND flash memory has increased twice per year since 1999. As the degree of integration of NAND flash memory has increased, the potentiality of being a new storage device capable of replacing existing hard disks has been recognized. SSDs have strong potentiality of replacing hard disks because they are lighter, have faster processing speed and consume lower power than hard disks.

As an example, SSDs including a plurality of NAND flash chips and a control device have already replaced hard disks in portable computers.

NAND flash memory includes a plurality of blocks, and each block includes a plurality of pages. For example, a single NAND flash chip provided in a SSD may include 8192 blocks, and each block may include 64 pages.

Flash memory including NAND flash memory is characterized in that read and write operations are performed on a page basis, an erase operation is performed on a block basis, and upon updating data, a corresponding space cannot be directly overwritten with updated data, and new data can be written at the location only when a corresponding block is erased or deleted. Due to the above characteristics, in NAND flash memory, a location at which data has been previously recorded cannot be directly overwritten with updated data, but the data should be recorded at a new location (out-of-place update) and then location information should be updated.

Furthermore, in the case of flash memory, the number of write and erase operation is commonly limited to a predetermined number. Accordingly, if the same block is used a number of times larger than the limited number, the data error occurrence rate of the block rapidly increases, and thus normal use is not possible any longer. Therefore, when data is updated, a wear-leveling method of erasing a corresponding block for a subsequent task and recording the updated data in a new block, rather than erasing a corresponding block and recording the updated data in the erased block, is used.

Because of the above-described characteristics of NAND flash memory, system software called a flash translation layer (hereinafter abbreviated to an “FTL”) and configured to enable NAND flash memory to emulate a hard disk is used between the file system of a host system designed based on a hard disk and NAND flash memory.

An FTL functions to hide the unique characteristics of NAND flash memory from the file system of a host system, and to map logical addresses transferred from a file system to the physical addresses of NAND flash memory in order to allow input/output operations identical to those of hard disk to be performed.

An SSD may include Single-Level Cell (SLC) or Multi-Level Cell (MLC) flash memory, and MLC flash memory is configured such that a plurality of bits (e.g., two bits) can be stored in a single memory cell, thereby enabling the high-level integration of memory to be achieved.

An SSD using MLC flash memory is disadvantageous in that it has slower processing speed and a shorter block life than an SSD using SLC flash memory, but is advantageous in that the number of pages per block is twice that of an SSD using SLC flash memory, the price thereof is relatively inexpensive, and the capacity thereof can be easily increased, thus being favorable for the popularization of SSDs.

Although MLC flash memory has the disadvantage of having slower processing speed than SLC flash memory, it maximally increases the processing speed of flash memory by supporting parallel processing because a current SSD is designed based on a multi-channel and multi-way structure. Accordingly, in an SSD including MLC flash memory, a parallel processing method acts as an important factor for increasing speed.

Generally, a multi-channel and multi-way type SSD has a structure for enabling a plurality of channels to be accessed at the same time and even a plurality of flash memory chips to be accessed at the same time from a single channel in order to maximize parallelism. Furthermore, in order to maximally utilize the above-described multi-channel and multi-way structure, the processing speed is increased by recording data in flash memory on a superblock (in which a plurality of logic blocks has been combined) basis.

As an example of an improvement of such a superblock, the preceding document “A Management Strategy for the Reliability and Performance Improvement of MLC-Based Flash-Memory Storage Systems,” Y.-H. Chang and T.-W. Kuo, IEEE Transactions on Computers, 60(3), pp. 305-320, 2011 proposes the FTL system of a chip-level parallel flash memory.

However, the technology disclosed in the preceding document does not include an algorithm for efficiently collecting information transmitted from a file system on a sector basis, and is thus problematic in that sub page-sets in which an empty space is present in a page-set are generated, with the result that unnecessary write operations are performed.

Furthermore, Korean Patent No. 10-0988388 entitled “Method of Improving Performance of Flash Memory Device and Flash Memory Device for Performing Same” proposes a plane-level parallel FTL and a configuration for performing superblock-based write operations. Furthermore, this patent describes a configuration for storing write data in a buffer and storing write data in flash memory at one time.

However, the preceding patent focuses on an algorithm for selecting a victim superblock when a superblock-based merge operation is performed, and does not include a configuration for rectifying write operations to be stored in a superblock. Accordingly, the preceding patent is still problematic in that the efficiency of the storage space of a superblock is low.

As a result, there is a need for the development of an information identification algorithm for reducing sub page-set in which an empty space is present in a page-set, thereby improving the efficiency of the storage space of a superblock.

### SUMMARY OF THE DISCLOSURE

Accordingly, the present invention has been made keeping in mind the above problems occurring in the prior art, and an object of the present invention is to provide an algorithm for reconfiguring sector-based data transmitted from a file system into a page-set in order to improve the performance of chip-level parallel flash memory.

An object of the present invention is to propose a buffering algorithm for efficiently using the physical storage space of flash memory in flash memory adopting a page-set or block-set type parallel structure in order to improve read/write performance.

An object of the present invention is to propose a data buffering algorithm and structure that are capable of reducing the number of physical write/erase operations performed on flash memory when page-set data is reconfigured. Furthermore, an object of the present invention is to propose an algorithm, method and device for identifying write data or write operation information based on the characteristics of data in order to reduce the number of physical write/erase operations.

In order to accomplish the above objects, the present invention includes a buffering layer configured to efficiently reconfigure write operation information transmitted from a file system to page-set or block-set type flash memory. A storage device according to an example of the present invention includes a controller and a non-volatile memory unit. The controller includes a few sub-modules such as a size determination unit, a logical address determination unit, an attribute information page-set buffer, a user information page-set buffer, a partial user information page-set buffer, a full page-set determination unit, and a session termination determination unit. It can be expressed as in this case for attribute information page-set buffer is first buffer, user information page-set buffer is second buffer and partial user information page-set buffer is third buffer.

The size determination unit compares the size of first write operation information received from the file system with a preset reference size, and stores the first write operation information in the attribute information page-set buffer if the size of the first write operation information is smaller than the reference size. If the size of the first write operation information is equal to or larger than the preset reference size, the first write operation information is moved to the logical address determination unit.

The logical address determination unit determines whether the logical address of the write operation information received from the size determination unit is associated with the logical address of second write operation information stored in the user information page-set buffer. If there is the association, the logical address determination unit stores the first write operation information in the user information page-set buffer. If there is no association, the second write operation information stored in the user information page-set buffer is moved to the partial user information page-set buffer, and the first write operation information is stored in the user information page-set buffer.

The full page-set determination unit determines whether write operation information stored in the attribute information page-set buffer and the user information page-set buffer forms a full page-set. If the write operation information stored in at least one of the attribute information page-set buffer and the user information page-set buffer forms a full page-set, the write operation information of the buffer in which the full page-set is formed is stored in the flash memory. If a full page-set is not formed, whether the write operation information stored in the attribute information page-set buffer and the user information page-set buffer forms a full page-set is continuously determined.

When receiving a session termination signal, the session termination determination unit determines whether there is write operation information stored in the partial user information page-set buffer, and stores write operation information in the flash memory if there is the write operation information.

A method of indentifying write operation information according to another embodiment of the present invention identifies write operation information transmitted from a file system to page-set or block-set type flash memory as attribute write information and user write information. The method of identifying write operation information according to this embodiment includes, if the size of the first write operation information received from the file system is smaller than a predetermined reference size, storing the first write operation information in the attribute information page-set buffer; if the size of the first write operation information is equal to or larger than the reference size, determining whether the logical address of the first write operation information is associated with the logical address of second write operation information stored in a user information page-set buffer; and if the logical address of the first write operation information is associated with the logical address of the second write operation information, storing the first write operation information in the user information page-set buffer.

In this case, in the method of identifying write operation information according to the present invention, if the logical address of the first write operation information is not associated with the logical address of the second write operation information, the second write operation information may be moved to a partial user information page-set buffer. After the second write operation information has been moved to the partial user information page-set buffer, the first write operation information may be stored in the user information page-set buffer.

In the method of identifying write operation information according to the present invention, if write operation information stored in the attribute information page-set buffer or user information page-set buffer forms a full page-set as the first write operation information is stored, the write operation information forming the full page-set may be stored in the flash memory.

Whether the logical address of the first write operation information is associated with the logical address of the second write operation information may be determined based on there is spatial locality or sequentially between the logical addresses.

The device and method of identifying write operation information according to the present invention may be applied to page-set or block-set-based flash memory. Although the device and method of identifying write operation information according to the present invention are FTL-related technology suitable for an MLC-based chip-level parallel flash memory system, the device and method of identifying write operation information according to the present invention are not limited to the application to the MLC-based chip-level parallel flash memory system. That is, they may be applied to an SLC flash memory system, and may be applied to plane-level parallel page-set flash memory.

A chip-level parallel flash memory system requires an algorithm for efficiently collecting sector-based information transmitted from a file system into a page-set because a write and read operation unit is extended to a page-set. However, since such an algorithm is not disclosed in preceding documents or preceding patents, a problem arises in that the spatial efficiency and performance of flash memory is reduced.

In order to overcome the above problem, the present invention proposes an efficient algorithm for reducing sub-page-sets (the cases where an empty space is present in some sector/page of a physical page-set), thereby distinguishing attribute information from user information and separately storing them, with the result that all the sectors of flash memory can be used without waste and thus the overall performance and spatial efficiency of flash memory can be improved.

Accordingly, the software algorithm capable of improving the performance and spatial efficiency of flash memory has been developed, and can be utilized in the various industrial fields, such as the information industry, the electric/electronic field, the software field, etc.

Although the present invention has been described with a focus on MLC-based chip-level parallel flash memory, the core configuration of the present invention may be applied to page-set or block-set type parallel flash memory. In accordance with the present invention, sub page-sets can be minimized in page-set or block-set type parallel flash memory.

In accordance with the present invention, when page-set data is reconfigured, the number of physical write/erase operations performed on flash memory can be reduced by using a data identification and buffering algorithm. The data identification algorithm of the present invention identifies write data or write operation information based on the characteristics of data, thereby reducing the number of physical write/erase operations performed on flash memory and thus improving the spatial efficiency of the physical page-sets of the flash memory.

### BRIEF DESCRIPTION OF THE DRAWINGS

FIG. 1 illustrates a file system, a page-set buffering layer, and an address mapping layer for chip-level parallel flash memory according to an embodiment of the present invention;

FIG. 2 illustrates the conceptual configuration of a device and algorithm for identifying write operation information for chip-level parallel flash memory according to an embodiment of the present invention;

FIG. 3 is an operation flowchart of a method and algorithm for identifying information for a chip-level parallel flash memory according to an embodiment of the present invention;

FIG. 4 is an operation flowchart of the determination and storage of a full page-set in the attribute information page-set buffer according to an embodiment of the present invention;

FIG. 5 is an operation flowchart of the determination and storage of a full page-set in the user information page-set buffer according to an embodiment of the present invention;

FIG. 6 is an operation flowchart of the process of storing the data of the partial user information page-set buffer upon the termination of a session according to an embodiment of the present invention;

FIG. 7 is a diagram illustrating an embodiment of a process in which write operation information is stored in the attribute information page-set buffer 720 based on the size of the write operation information;

FIG. 8 is a diagram illustrating an embodiment of a process in which write operation information is stored in the user information page-set buffer 810 and forms a full page-set based on the association between the logical addresses of write operation information;

FIG. 9 is a diagram illustrating an embodiment of a case where if data stored in the user information page-set buffer forms a full page-set, the full page-set is stored in the flash memory and write operation information stored in the attribute information page-set buffer is in-place updated; and

FIG. 10 is a diagram illustrating an embodiment of a process in which the data of a user information page-set buffer is moved to a partial user information page-set buffer based on the association between the logical addresses of write operation information, and a process in which data stored in the partial user information page-set buffer is stored in flash memory when a session is terminated.

### DETAILED DESCRIPTION OF THE DISCLOSURE

The objects of the present invention other than the above objects and features will be apparent from the following description of embodiments with reference to the accompanying drawings.

Preferred embodiments of the present invention will be described in detail with reference to the accompanying drawings. In the following description of the present invention, if it is determined that detailed descriptions of related well-known configurations or functions may make the gist of the present invention obscure, the detailed descriptions will be omitted.

However, the present invention is not restricted or limited to the embodiments. The same reference symbols represented throughout the drawings designate the same elements.

The present invention relates to an information identification algorithm. In particular, the present invention was devised to identify and buffer write operation information transmitted from a file system to a page-set or block-set type flash memory by using an attribute information page-set buffer and a user information page-set buffer, thereby allowing the all the sectors of flash memory to be used and thus improving the overall performance and spatial efficiency of flash memory.

A conventional chip-level parallel flash memory system requires an algorithm for efficiently collecting sector-based information transmitted from a file system into a page-set because a write and read operation unit is extended to a page-set. However, since such an algorithm is not disclosed in preceding documents or preceding patents, a problem arises in that the spatial efficiency and performance of flash memory is reduced.

The present invention provides an information identification algorithm for independent chip-level parallel flash memory, which is capable of identifying write operation information to be stored in an attribute information page-set buffer and a user information page-set buffer using the size and logical address of write operation information transmitted from a file system to flash memory.

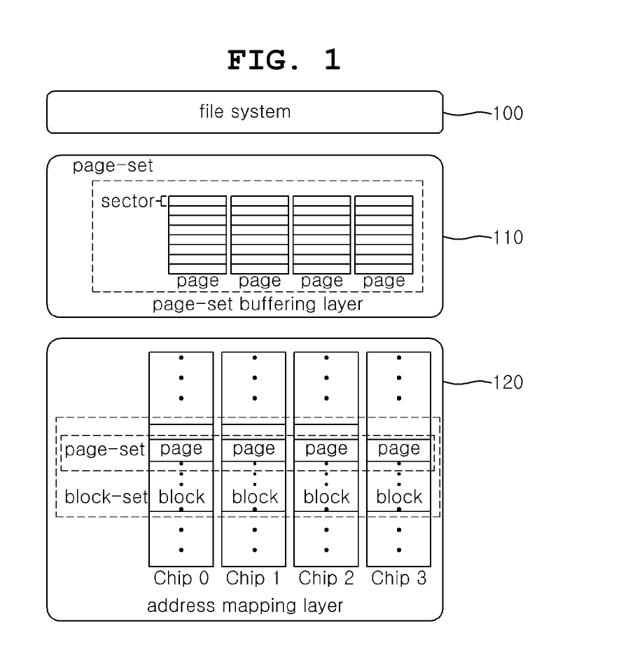

FIG. 1 illustrates the structure of a file system 100, a page-set buffering layer 110, and an address mapping layer 120 for chip-level parallel flash memory according to an embodiment of the present invention.

The file system 100 is a system for managing files stored in a storage medium, such as a hard disk or an SSD, in connection with an Operating system (OS), or the stored files and a structure in which the files have been stored. The file system 100 manages individual file and data using logical addresses, and transfers a read/write operation to flash memory.

The page-set buffering layer 110 identifies and separately manages attribute information and user information before storing write operation information received from the file system 100 in the address mapping layer 120, thereby functioning to eliminate a sub-page-set. This results in the improvement in the entire performance and spatial efficiency of flash memory.

The address mapping layer 120 functions to store write operation information transmitted from the file system 100 and identified by the page-set buffering layer 110.

In this case, the write operation information includes write data and logical address information. In some embodiments, the same type of one or more write operations may be grouped, and a set of write operations may be viewed as write operation information. In this case, the write operation information may include information about the size of data included in the set of write operations or the sizes of write operations.

For example, the write operation information may be represented in the form of “w, LSN, data, size.” In this case, “w” represents a write operation (the type of operation), “LSN” represents a logical address, such as a logical sector number, and “data” represents data, which is the object of a write operation. Finally, “size” represents the size of a write operation or write data. If the size is 2 or larger, the LSN may represent the start address of a write operation. If the size is 2 or larger, two or more write operations may be grouped and treated as a single piece of write operation information. Such grouping of write operations may be performed in the file system 100, in a layer higher than the file system 100, or in the page-set buffering layer 110.

The address mapping layer 120 is a layer that maps logical addresses to the physical addresses of flash memory. The term “flash translation layer (FTL)” often refers to the address mapping layer 120. Write operation information or write data that is identified by the page-set buffering layer 110 and forms a full page-set is stored in the flash memory via the address mapping layer 120.

The page-set buffering layer 110 identifies write operation information based on information, such as the size of write operation information and a logical address, and temporarily stores the write operation information, thereby reducing the sub page-set without performing a separate optimization process in the address mapping layer 120. Furthermore, if write operation information is a write operation related to attribute information, the page-set buffering layer 110 identifies the write operation information and performs update processing in the buffering layer 110, thereby reducing the number of times the write operation related to attribute information is transferred to the address mapping layer 120 and the number of write/erase operations in the flash memory and thus increasing the lifespan of the flash memory.

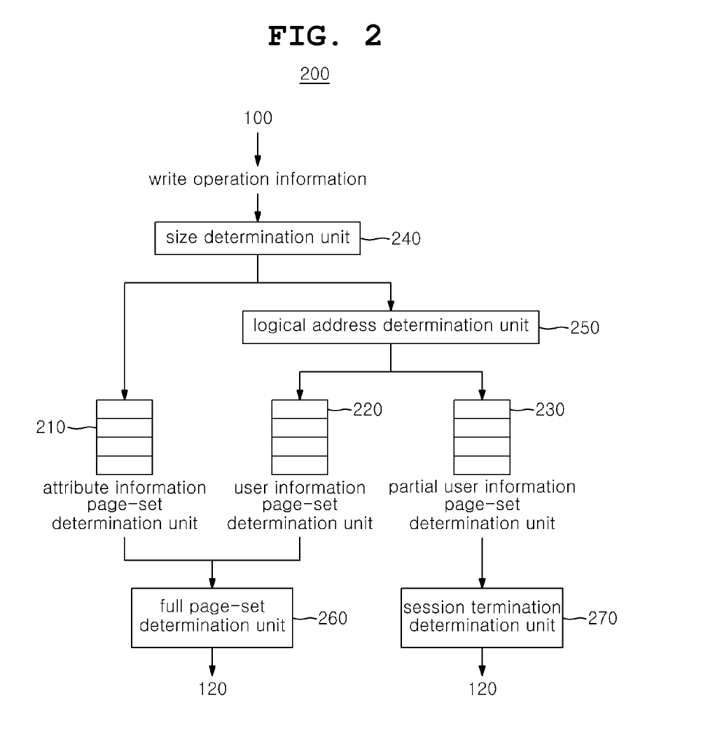

FIG. 2 illustrates the conceptual configuration of a device and algorithm for identifying write operation information for chip-level parallel flash memory according to an embodiment of the present invention.

As illustrated in FIG. 2, a device 200 for identifying write operation information according to the present invention includes a size determination unit 240, a logical address determination unit 250, an attribute information page-set buffer 210, a user information page-set buffer 220, a partial user information page-set buffer 230, a full page-set determination unit 260, and a session termination determination unit 270.

The size determination unit 240 receives first write operation information from the file system 100, compares the first write operation information with a preset predetermined reference size, determines that the first write operation information is write operation information related to attribute information if the first write operation information is smaller than the preset predetermined reference size, and stores the first write operation information in the attribute information page-set buffer 210. In this case, if write operation information having the same logical address as the first write operation information has been stored in the attribute information page-set buffer 210, an update is performed by overwriting the stored write operation information of the attribute information page-set buffer 210 with the first write operation information. If the first write operation information is equal to or higher than the preset predetermined reference size, it is determined that the first write operation information is write operation information related to user information, and the first write operation information is transmitted to the logical address determination unit 250.

The attribute information relates to the attribute of a file or management information, and is characterized in that it is frequently accessed and a logical address is randomly accessed. The user information relates to the content of a file or data, is characterized in that it is infrequently updated compared to attribute information and a logical address is sequentially accessed.

The logical address determination unit 250 determines whether the logical address of write operation information received from the size determination unit 240 is associated with the logical address of second write operation information stored in the user information page-set buffer 220. In this case, the second write operation information may be the last write operation information of write operation information stored in the user information page-set buffer 220. If the logical address of first write operation information is associated with the logical address of the second write operation information, the first write operation information is stored in the user information page-set buffer 220. In this case, the first write operation information may be sequentially stored in the user information page-set buffer 220 in close proximity to the second write operation information.

If the logical address of the first write operation information is not associated with the logical address of the second write operation information, the second write operation information stored in the user information page-set buffer 220 is moved to the partial user information page-set buffer 230. The user information page-set buffer 220 that had stored the second write operation information enters an empty state and stores first write operation information.

If logical addresses are not associated with each other, the most recently transferred first write operation information is stored in the user information page-set buffer 220, and previously stored second write operation information is moved to the partial user information page-set buffer 230, in light of temporal locality. In light of temporal locality, if a write operation subsequently transferred from the file system 100 is a write operation related to user information, it is expected that the possibility of being associated with recent first write operation information is stronger than the possibility of being associated with previous second write operation information. If there is no empty space in the page-set buffer, the full page-set determination unit 260 may consider that a full page-set has been completed by write operation information because the size of the page-set buffer among the attribute information page-set buffer 210 and the user information page-set buffer 220 corresponds to the size of the full page-set. If the write operation information stored in the page-set buffer completes a full page-set, the write operation information may be stored in the flash memory and the page-set buffer may be returned to an empty state. Thanks to the above operation of the page-set buffering layer 110 according to the present invention, the number of cases where a sub page-set is stored in the flash memory can be reduced, thereby increasing the efficiency of operation information stored in the flash memory. Furthermore, thanks to the operation of the page-set buffering layer 110 according to the present invention, the number of times write operation information is actually stored in the flash memory can be reduced, and thus the number of write/erase operations of the flash memory can be reduced and also the lifespan of the flash memory can be increased.

When receiving the session termination signal of the flash memory in response to user or software input, the session termination determination unit 270 stores the write operation information stored in the partial user information page-set buffer 230 in the flash memory. An example in which a session is terminated may be a case where a user separates a flash memory device from the OS or power is turned off. That is, a case where a user input intention to separate a flash memory device coupled to a PC via a USB port to the PC corresponds to the example. In this case, write operation information stored in the partial user information page-set buffer 230 is stored in the flash memory via the address mapping layer 130 in order to prevent write operation information from being lost.

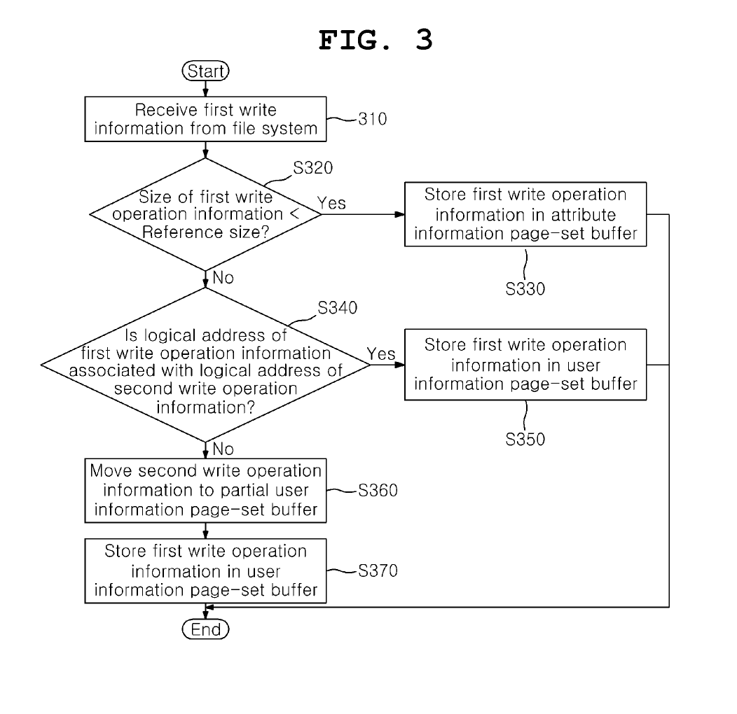

FIG. 3 is an operation flowchart of a method and algorithm for identifying information for a chip-level parallel flash memory according to an embodiment of the present invention.

Referring to FIG. 3, the page-set buffering layer 110 of the present invention receives first write operation information from the file system 100 at step S310.

The size determination unit 240 compares the size of the first write operation information with a preset predetermined reference size at step S320, stores the first write operation information in the attribute information page-set buffer 210 if the size of the first write operation information is smaller than the reference size at step S330. If, as a result of the determination at step S320, it is determined that the size of the first write operation information is equal to or larger than the reference size, the logical address determination unit 250 determines whether the logical address of the first write operation information is associated with the logical address of second write operation information stored in the user information page-set buffer 220 at step S340, and stores the first write operation information in the user information page-set buffer 220 if the logical address of the first write operation information is associated with the logical address of the second write operation information at step S350. If the logical address of the first write operation information is not associated with the logical address of the second write operation information, the logical address determination unit 250 or page-set buffering layer 110 moves the second write operation information stored in the user page-set buffer 220 to the partial user information page-set buffer 230 at step S360, and stores the first write operation information in the user information page-set buffer 220 at step S370.

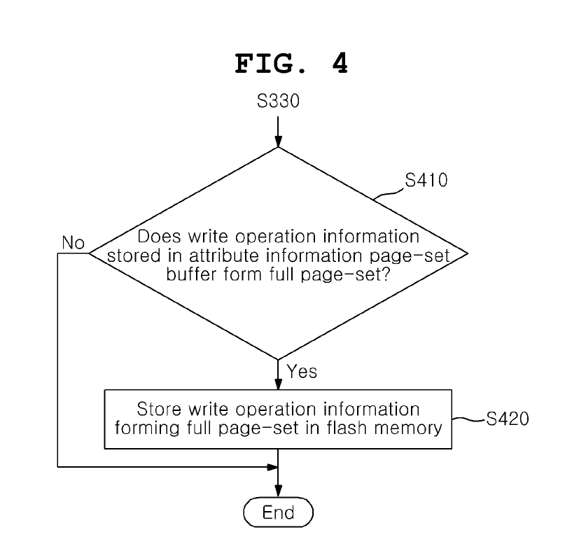

FIG. 4 is an operation flowchart of the determination and storage of a full page-set in the attribute information page-set buffer 210 according to an embodiment of the present invention.

Referring to FIG. 4, the full page-set determination unit 260 determines whether the write operation information, stored in the attribute information page-set buffer 210 at step S330, forms a full page-set at step S410. If the write operation information stored in the attribute information page-set buffer 210 forms a full page-set, the page-set buffering layer 110 stores the write operation information forming a full page-set in the flash memory at step S420. If the write operation information stored in the attribute information page-set buffer 210 does not form a full page-set, whether a full page-set is formed is determined at step S410 when another piece of write operation information is stored in the attribute information page-set buffer 210 at step S330.

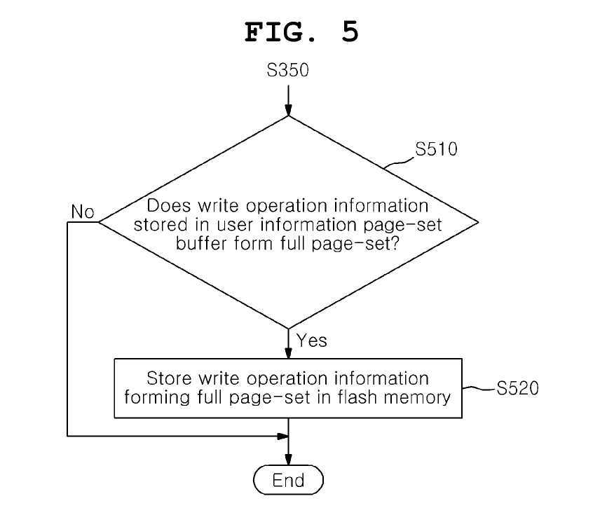

FIG. 5 is an operation flowchart of the determination and storage of a full page-set in the user information page-set buffer 220 according to an embodiment of the present invention.

Referring to FIG. 5, the full page-set determination unit 260 determines whether the write operation information, stored in the user information page-set buffer 220 at step S350, forms a full page-set at step S510. If the write operation information stored in the user information page-set buffer 220 forms a full page-set, the page-set buffering layer 110 stores the write operation information forming a full page-set in the flash memory at step S520. If the write operation information does not form a full page-set, it is determined at step S510 whether a full page-set is formed when another piece of write operation information is stored in the user information page-set buffer 220 at step S350.

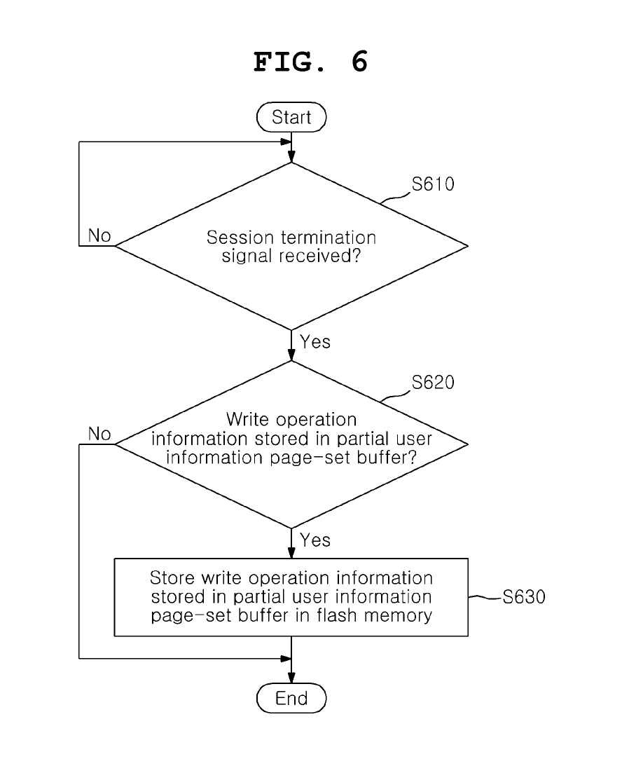

FIG. 6 is an operation flowchart of the process of storing the data of the partial user information page-set buffer 230 upon the termination of a session in the session termination determination unit 270 according to an embodiment of the present invention.

If the session termination determination unit 270 receives a session termination signal while continuously waiting for the reception of a session termination signal during user or programming at step S610, the page-set buffering layer 110 determines whether write operation information has been stored in the partial user information page-set buffer 230 at step S620. If write operation information has been stored, the page-set buffering layer 110 stores the write operation information stored in the partial user information page-set buffer 230 in the flash memory at step S630, and then prepares the determination of a session. If operation information has not been stored, the termination of a session is prepared.

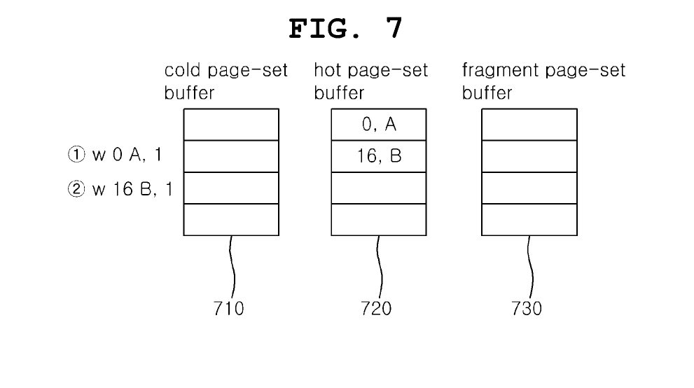

FIG. 7 is a diagram illustrating an embodiment of a process in which write operation information is stored in the attribute information page-set buffer 720 based on the size of the write operation information.

Hereinafter, cold page-set buffers 710, 810, 910 and 1010 illustrated in FIGS. 7, 8, 9 and 10 represent user information page-set buffers, and hot page-set buffers 720, 820, 920 and 1020 present attribute information page-set buffers. Furthermore, fragment page-set buffers 730, 830, 930 and 1030 represent partial user information page-set buffers. User information is represented by a cold page-set because the number of times it is updated is relatively small, and attribute information is represented by a hot page-set because it is relatively frequently updated.

Referring to FIG. 7, if two pieces of write operation information \textcircled{1} (w 0 A, 1) and \textcircled{2} (w 16 B, 1) are received from the file system 100, the size of the two pieces of write operation information is smaller than a predetermined reference size (=2), and thus two pieces of write operation information are sequentially stored in the attribute information page-set buffer hot page-set buffer 720. In this case, information that is stored in the page-set buffer 710, 720 and 730 may be the same as the received write operation information, or part of the received write operation information is extracted and stored. For example, if write operation information \textcircled{1} (w 0 A, 1) is received, write data A and logical address 0 may be stored in the page-set buffer 720.

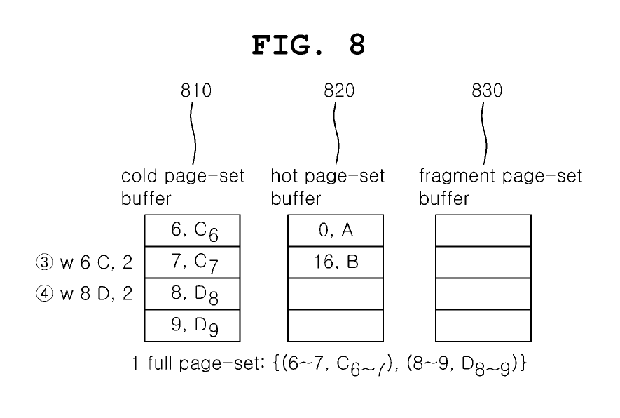

FIG. 8 is a diagram illustrating an embodiment of a process in which write operation information is stored in the user information page-set buffer 810 and forms a full page-set based on the association between the logical addresses of write operation information.

Referring to FIG. 8, since the size of another piece of write operation information \textcircled{3} (w 6 C, 2) received from the file system 100 in the state in which two pieces of write operation information \textcircled{1} (w 0 A, 1) and \textcircled{2} (w 16 B, 1) have been stored in the attribute information page-set buffer hot page-set buffer 820 is equal to or larger than the preset predetermined reference size (=2), the write operation information \textcircled{3} (w 6 C, 2) is stored in the user information page-set buffer 810. Thereafter, since the size of received write operation information \textcircled{4} (w 8 D, 2) is equal to or larger than the reference size, the write operation information \textcircled{4} (w 8 D, 2) is identified as user information write operation.

Meanwhile, in a state in which the write operation information \textcircled{3} (w 6 C, 2) has been stored in the user information page-set buffer 810, the last logical address of the user information page-set buffer 810 is “7,” and the start logical address of subsequently received write operation information \textcircled{4} (w 8 D, 2) is “8” Accordingly, since there is the association between the logical addresses, the write operation information \textcircled{4} (w 8 D, 2) is sequentially stored in the user information page-set buffer cold page-set buffer 810 immediately after the write operation information \textcircled{3} (w 6 C, 2). In this case, thanks to the write operation information stored in the user information page-set buffer cold page-set buffer 810, the write operation information stored in the user information page-set buffer cold page-set buffer 810 forms a full page-set. In the embodiments of FIGS. 7 to 10, the case where the size of a page-set is four is considered. Since the write operation information stored in the user information page-set buffer 810 forms a full page-set, the full page-set is stored in the flash memory via the address mapping layer 120.

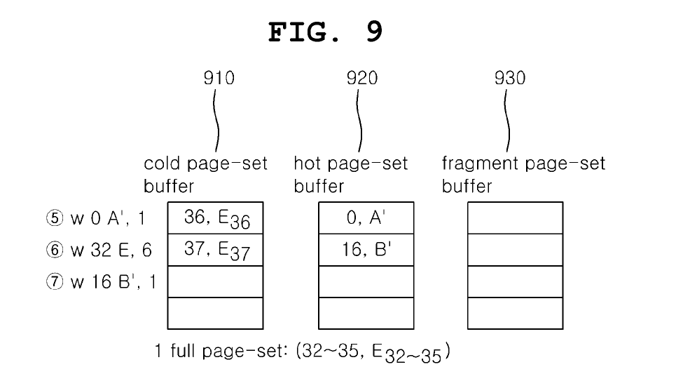

FIG. 9 is a diagram illustrating an embodiment of processes in which, if data stored in the user information page-set buffer forms a full page-set, the full page-set is stored in the flash memory and write operation information stored in the attribute information page-set buffer 920 is in-place updated.

Referring to FIG. 9, in the state in which two pieces of operation information \textcircled{1} (w 0 A, 1) and \textcircled{2} (w 16 B, 1) from the file system 100 have been stored in the attribute information page-set buffer hot page-set buffer 920, operation information \textcircled{3} (w 6 C, 2) and operation information \textcircled{4} (w 8 D, 2) stored in the user information page-set buffer cold page-set buffer 910 form a full page-set. Accordingly, the operation information \textcircled{3} (w 6 C, 2) and the operation information \textcircled{4} (w 8 D, 2) forming a full page-set are stored in the flash memory, and the user information page-set buffer 910 enters an empty state. Thereafter, other pieces of write operation information \textcircled{5} (w 0 A′, 1), \textcircled{6} (w 32 E, 6) and \textcircled{7} (w 16 B′, 1) are sequentially received from the file system 100.

Since the size of the write operation information \textcircled{5} (w 0 A′, 1) is smaller than the reference size, it is stored in the attribute information page-set buffer 920. In this case, existing write operation information \textcircled{1} (w 0 A, 1) having a logical address of “0” identical to the logical address of newly received write operation information \textcircled{5} (w 0 A′, 1) has been stored in the attribute information page-set buffer 920, write operation information \textcircled{5} (w 0 A′, 1) newly received by the attribute information page-set buffer 920 replaces the existing write operation information \textcircled{1} (w 0 A, 1) by overwriting the existing write operation information \textcircled{1} (w 0 A, 1).

Meanwhile, since the size of write operation information \textcircled{6} (w 32 E, 6) is equal to or larger than the reference size (=2) and the user information page-set buffer 910 is empty, the write operation information \textcircled{6} (w 32 E, 6) is sequentially stored in the user information page-set buffer 910. In this case, thanks to write operations E32˜35 that belong to the write operation information \textcircled{6} (w 32 E, 6) and correspond to logical addresses 32 to 35, write data stored in the user information page-set buffer 910 forms a single full page-set, the page-set buffering layer 110 stores the write operations E32˜35 corresponding to the logical addresses 32 to 35 in the flash memory via the address mapping layer 120. After transferring the full page-set to the flash memory, the user information page-set buffer 910 enters an empty state again.

The write operation information (logical addresses 36˜37, data E36-37) of \textcircled{6} (w 32 E, 6) remaining after the storage in the flash memory is stored in the user information page-set buffer cold page-set buffer 910 that has enter an empty state.

Since the size of write operation information \textcircled{7} (w 16 B′, 1) is smaller than the preset predetermined reference size, the write operation information \textcircled{7} (w 16 B′, 1) is indentified as an attribute information write operation. Meanwhile, since the logical address “16” of the newly received write operation information \textcircled{7} (w 16 B′, 1) is the same as the logical address “16” of the write operation information \textcircled{2} (w 16 B, 1) previously stored in the attribute information page-set hot page-set buffer 920, the attribute information page-set buffer 920 in-place updates the previously stored write operation information \textcircled{2} (w 16 B, 1) with the newly received write operation information \textcircled{7} (w 16 B′, 1).

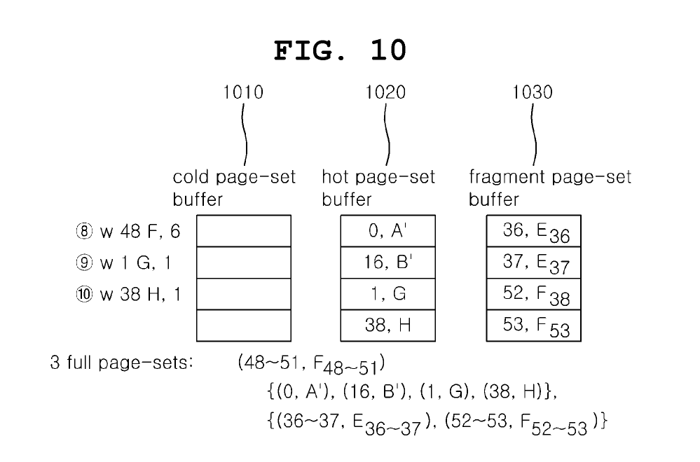

FIG. 10 is a diagram illustrating an embodiment of a process in which the data of the user information page-set buffer 1010 is moved to the partial user information page-set buffer 1030 based on the association between the logical addresses of write operation information, and a process in which data stored in the partial user information page-set buffer 1030 is stored in flash memory when a session is terminated.

Referring to FIG. 10, the page-set buffering layer 110 identifies the sizes and logical addresses of three pieces of operation information \textcircled{8} (w 48 F, 6), \textcircled{9} (w 1 G, 1) and \textcircled{1}0 (w 38 H, 1) sequentially received from the file system 100, and stores them in the user information page-set buffer 1010, the attribute information page-set buffer 1020, and the partial user information page-set buffer 1030.

The case where write operation information \textcircled{8} (w 48 F, 6) is received in the state in which write operation information (36˜37, E36˜37) has been stored in the user information page-set buffer 1010, as illustrated in FIG. 9, is considered. Since the size of the write operation information \textcircled{8} (w 48 F, 6) is larger than the reference size, the write operation information \textcircled{8} (w 48 F, 6) is identified as a user information write operation.

Meanwhile, it may be determined that “48,” which is the start logical address of the write operation information \textcircled{8} (w 48 F, 6) is associated with “37,” which is the logical address of write operation stored last in the user information page-set buffer 1010. The logical addresses “48” and “37” are neither sequential not adjacent to each other.

Accordingly, the page-set buffering layer 110 moves existing write operation information (36˜37, E36˜37) to the partial user information page-set buffer 1030. Thereafter, the user information page-set buffer 1010 enters an empty state, and newly received write operation information \textcircled{8} (w 48 F, 6) is sequentially stored in the user information page-set buffer 1010.

Since the size of the write operation information \textcircled{8} (w 48 F, 6) is larger than the size (=4) of a full page-set, a single full page-set is completed with the preceding write operation information (48˜51, F48˜51) of the write operation information \textcircled{8} (w 48 F, 6) stored in the user information page-set buffer 1010. The write operation information (48˜51, F48˜51) completing a full page-set is stored in the flash memory via the address mapping layer 120. After the write operation information (48˜51, F48˜51) has been stored in the flash memory, the user information page-set buffer 1010 enters an empty state again.

Thereafter, the write operation information (52˜52, F52˜53) of the write operation information \textcircled{8} (w 48 F, 6) remaining after the storage in the flash memory is stored in the user information page-set buffer cold page-set buffer 1010.

Since the size of each of write operation information \textcircled{9} (w 1 G, 1) and write operation information \textcircled{10} (w 38 H, 1) is smaller than the reference size, the write operation information \textcircled{9} (w 1 G, 1) and write operation information \textcircled{10} (w 38 H, 1) are sequentially stored in the attribute information page-set buffer 1020. In this case, since the logical addresses of the write operation information \textcircled{9} (w 1 G, 1) and the write operation information \textcircled{10} (w 38 H, 1) do not match the logical addresses of previously stored write operation information, the write operation information \textcircled{9} (w 1 G, 1) and the write operation information \textcircled{10} (w 38 H, 1) are sequentially stored in the empty space of the attribute information page-set buffer 1020.

Thanks to the storage of the write operation information \textcircled{9} (w 1 G, 1) and the write operation information \textcircled{10} (w 38 H, 1), the write operation information stored in the attribute information page-set buffer 1020 completes a single full page-set.

In this state, when a session termination signal is received, the page-set buffering layer 110 stores the write operation information (52˜53, F52˜53) stored in the user information page-set buffer 1010 in the empty space of the partial user information page-set buffer 1030, thereby inducting the write operation information stored in the partial user information page-set buffer 1030 to form a single full page-set.

Since data stored in the page-set buffers 1010, 1020 and 1030 may be lost after a session has been terminated, the page-set buffering layer 110 stores a single full page-set stored in the attribute information page-set buffer 1020 and another single full page-set stored in the partial user information page-set buffer 1030 in the flash memory via the address mapping layer 120, and then prepares the termination of a session.

The method of identifying write operation information for flash memory according to the embodiments of the present invention may be implemented in the form of program instructions that can be executed by a variety of computer means, and may be stored in a computer-readable storage medium. The computer-readable storage medium may include program instructions, a data file, and a data structure solely or in combination. The program instructions that are stored in the medium may be designed and constructed particularly for the present invention, or may be known and available to those skilled in the field of computer software. Examples of the computer-readable storage medium include magnetic media such as a hard disk, a floppy disk and a magnetic tape, optical media such as CD-ROM and a DVD, magneto-optical media such as a floptical disk, and hardware devices particularly configured to store and execute program instructions such as ROM, RAM, and flash memory. Examples of the program instructions include not only machine language code that is constructed by a compiler but also high-level language code that can be executed by a computer using an interpreter or the like. The above-described hardware components may be configured to act as one or more software modules that perform the operation of the present invention, and vice versa.

Although the present invention has been described in conjunction with specific details, such as specific components, and limited embodiments and drawings, these are provided merely to help the general understanding of the present invention, but the present invention is not limited to the above embodiments. Those having ordinary knowledge in the field of art to which the present invention pertains can make various modifications and variations based on the foregoing description.

Accordingly, the spirit of the present invention should not be defined based on the described embodiments, and all including not only the following claims but also the equivalents of the claims and equivalent modification are included in the scope of spirit of the present invention.

What is claimed is:

1. A method of managing information transmitted from a file system to a storage device that includes a non-volatile memory and a controller, the method comprising:
storing, by the controller, first write operation information in a first buffer, if a size of the first write operation information received from the file system is smaller than a predetermined reference size;
determining, by the controller, whether a logical address of the first write operation information is associated with a logical address of second write operation information stored in a second buffer, if the size of the first write operation information is equal to or larger than the reference size; and
storing, by the controller, the first write operation information in the second buffer, if the logical address of the first write operation information is associated with the logical address of the second write operation information.

2. The method of claim 1, further comprising:
moving, by the controller, the second write operation information to a third buffer, if the logical address of the first write operation information is not associated with the logical address of the second write operation information; and
storing, by the controller, the first write operation information in the second buffer, after the second write operation information has been moved to the third buffer.

3. The method of claim 1, further comprising:
storing, by the controller, the write operation information forming the full page-set in the non-volatile memory, if write operation information stored in the first buffer in which the first write operation information has been stored or the second buffer forms a full page-set due to the first write operation information.

4. The method of claim 1, wherein a size of at least one of the first buffer and the second buffer corresponds to a size of a full page-set.

5. The method of claim 1, wherein storing the first write operation information in the first buffer comprises, if write operation information having a logical address identical to that of the first write operation information has been already stored in the first buffer, updating the first buffer by overwriting the first buffer with the first write operation information.

6. The method of claim 1, wherein the association between the logical address of first write operation information and the logical address of second write operation information is spatial locality or sequentiality between the logical addresses.

7. The method of claim 2, further comprising:
storing, by the controller, the write operation information stored in the third buffer in the flash memory, if a session for the flash memory has been terminated.

8. A non-transitory computer-readable medium containing executable program instructions, executed by a controller, for executing a method of managing information transmitted from a file system to a storage device that includes a non-volatile memory and the controller, comprising:
program instructions that store first write operation information in a first buffer, if a size of the first write operation information received from the file system is smaller than a predetermined reference size;
program instructions that determine whether a logical address of the first write operation information is associated with a logical address of second write operation information stored in a second buffer, if the size of the first write operation information is equal to or larger than the reference size; and
program instructions that store the first write operation information in the second buffer, if the logical address of the first write operation information is associated with the logical address of the second write operation information.

9. A storage device that includes a non-volatile memory comprising:
a first buffer configured to store write operation information of a size smaller than a preset predetermined reference size;
a second buffer configured to store write operation information of a size equal to or larger than the reference size;
a controller is configured to:
identify the size of first write operation information transmitted from a file system to a flash memory;
store the first write operation information in the first buffer, if a size of the first write operation information received from the file system is smaller than the reference size; and
store the first write operation information in the second buffer, if the size of the first write operation information is equal to or larger than the reference size and also a logical address of the first write operation information is associated with a logical address of second write operation information stored in the second buffer.

10. The storage device of claim 9, further comprising:
a third buffer configured to store the second write operation information moved from the second buffer, and
wherein the controller is further configured to move the second write operation information to the third buffer if the logical address of the first write operation information is not associated with the logical address of the second write operation information.

11. The storage device of claim 9, the controller is further configured to:
store write operation information forming the full page-set in the flash memory, if write operation information stored in at least one of the first buffer and the second buffer forms a full page-set.

12. The appa storage device ratus of claim 9, the first buffer is further configured to:
update previously stored first write operation information with third write operation information presently received from the file system by overwriting the previously stored write operation information with the third write operation information if the third write operation information having a logical address identical to that of the previously stored first write operation information.

13. The storage device of claim 10, the controller is further configured to:
store the write operation information stored in the third buffer in the flash memory if a session for the flash memory has been terminated.
